(19) United States
(12) Patent Application Publication
(10) Pub. No.: US 2025/0389826 A1
(43) Pub. Date: Dec. 25, 2025

(54) AUTOMOTIVE ELECTRONIC SYSTEM

(71) Applicant: Trend Technology (Xiamen) Inc., Xiamen (CN)

(72) Inventors: Tai Shih Cheng, Taipei City (TW); Shui Ying Lin, Xiamen City (CN); Che Chia Chang, New Taipei City (TW); De Guo Huang, Zhangzhou City (CN); Pei Hua Yang, Taoyuan County (TW)

(21) Appl. No.: 19/229,090

(22) Filed: Jun. 5, 2025

(30) Foreign Application Priority Data
Jun. 25, 2024 (CN) 202410824033.1

(51) Int. Cl. G01S 7/487; G01S 7/481; G01S 17/931

(52) U.S. Cl. CPC G01S 7/487; G01S 7/4813; G01S 17/931

(57) ABSTRACT

An automotive LiDAR system includes a laser device and a windshield. The laser device includes an enclosure, a light source, and a receiver. The enclosure includes a housing with an opening and a light-transmitting window disposed in the opening. The light-transmitting window includes magnetically conductive material configured to absorb electromagnetic waves in a wavelength band of about 1600 nm to about 2000 nm. The light source is disposed within the enclosure and configured to emit a light beam having a wavelength band of about 1500 nm to about 1600 nm. The receiver is disposed within the enclosure and configured to detect optical signals in a wavelength band of about 1450 nm to about 2000 nm. The windshield faces the light-transmitting window and is configured to have a reflectance of about 8% to about 10% for environmental electromagnetic waves in a wavelength band of about 1600 nm to about 2000 nm.

### FIELD OF DISCLOSURE

The present disclosure relates to an automotive electronic system.

### DESCRIPTION OF RELATED ART

A light detection and ranging (LiDAR) system is a technology that uses light to detect an object's shape and range. The LiDAR systems have been applied to various fields, including autonomous vehicles, drones, and detection of the surrounding topographical landscape and environment. Please refer to FIG. 1, which is a comparison chart of wavelength band, frequency, and wavelength of radio. As shown in FIG. 1, the LiDAR systems generally use the near-infrared spectrum that is near the adjacent microwave band and can be easily interfered with. In other words, a poor signal-to-noise ratio (SNR or S/N) of the targeted wavelength band signal would lead to an inaccurate measurement by the LiDAR system.

The technology currently available mainly adopts the following methods to improve the signal-to-noise ratio of a LiDAR system: (1) shielding light of specific wavelength bands by the use of shielding materials, for example, those described in the Chinese patent of publication number CN213210525U; (2) filtering stray light of specific wavelength bands by the use of filters; (3) using light sources with good resistance to interference; and (4) eliminating the impact of optical signals in specific wavelength bands using digital signal processing technology. However, these methods all have certain limitations. For example, the addition of shielding layers would increase the weight and volume of the LiDAR system; filtering light of specific wavelength bands would lower the sensitivity of the LiDAR system; the cost of light sources with good resistance to interference is higher; the complexity of digital signal processing technology is higher.

Therefore, to introduce a solution that can solve the aforementioned problems of the automotive LiDAR system is what the industry invests its research and development resources in and intends to achieve.

### SUMMARY OF THE DISCLOSURE

In view of this, one objective of the present disclosure is to provide an automotive LiDAR system that can solve the aforementioned problems.

In order to achieve the aforementioned objective, an automotive light detection and ranging (LiDAR) system comprises a laser device and a windshield, based on one embodiment of the present disclosure. The laser device comprises an enclosure, a light source, and a receiver. The enclosure comprises a housing with an opening and a light-transmitting window disposed in the opening. The light-transmitting window comprises a magnetically conductive material configured to absorb electromagnetic waves in a wavelength band of about 1600 nm to about 2000 nm. The light source is disposed within the enclosure and configured to emit a light beam having a wavelength band of about 1500 nm to about 1600 nm. The receiver is disposed within the enclosure and configured to detect optical signals in a wavelength band of about 1450 nm to about 2000 nm. The windshield faces the light-transmitting window and is configured to have a reflectance of about 8% to about 10% for environmental electromagnetic waves in a wavelength band of about 1600 nm to about 2000 nm.

In one or several embodiments of the present disclosure, the light beam passes through a part of the windshield, and the aforementioned part is tilted with respect to the light-transmitting window.

In one or several embodiments of the present disclosure, the aforementioned part of the windshield has an inclination angle smaller than about 50 degrees with respect to the light-transmitting window.

In one or several embodiments of the present disclosure, the inclination angle is larger than about 20 degrees.

In one or several embodiments of the present disclosure, the inclination angle ranges from about 40 degrees to about 45 degrees.

In one or several embodiments of the present disclosure, the windshield is made of bare glass.

In one or several embodiments of the present disclosure, the windshield comprises a substrate component and a splicing component. The substrate component has a gap. The splicing component is spliced in the gap and has a concave part. The laser device is disposed at least partially within the concave part.

In one or several embodiments of the present disclosure, the light beam passes through a part of the splicing component. An inclination angle of the aforementioned part with respect to the light-transmitting window is smaller than an inclination angle of the substrate component with respect to the light-transmitting window.

In one or several embodiments of the present disclosure, the magnetically conductive materials comprise p-type dopants or n-type dopants.

In one or several embodiments of the present disclosure, the light beam passes through the aforementioned part of the windshield. The aforementioned part comprises a plurality of microstructures.

In summary, for the detectable wavelength bands of the receiver of the laser device in the automotive LiDAR system of the present disclosure, using the light-transmitting window of the laser device to absorb environmental electromagnetic waves of specific wavelength bands, together with a windshield to reflect the aforementioned environmental electromagnetic waves of specific wavelength bands to a certain degree, the signal-to-noise ratio of the receiver for detecting the optical signals (corresponding to the wavelength bands of the light beam emitted from the light source of the laser device) of the desired wavelength bands can be improved effectively. By limiting the inclination angle of the windshield with respect to the light-transmitting window of the laser device to be smaller than 50 degrees, the windshield can meet the aforementioned effect of reflecting electromagnetic interference. By adding p-type dopants or n-type dopants in the magnetically conductive materials of the light-transmitting window, the light-transmitting window can meet the aforementioned comprehensive effect of absorbing electromagnetic waves. The spirit of the present disclosure is to use the light-transmitting window of the laser device to simultaneously introduce the concept of absorbing material and, furthermore, to combine the complex, comprehensive effect of utilizing the windshield to reflect the wavelength bands that do not belong to the desired wavelength bands specified by the receiver, in order to eliminate environmental light and improve the signal-to-noise ratio effectively. By disposing microstructures in the part of the windshield where the light beams pass through, the transmittance of the light beam in the windshield will increase, and the transmittance deterioration of every inclination angle can be reduced.

The aforementioned statements are used to explain problems that the present disclosure can solve, the technical means for solving the problems, and the effect thereof. The present disclosure will become more fully understood from the detailed descriptions given herein below by way of embodiments with reference to the accompanying drawings for illustration only.

### BRIEF DESCRIPTION OF THE DRAWINGS

To better understand the novel features, contents, and advantages of the present disclosure, detailed descriptions of the present disclosure are provided as follows, accompanied by diagrams and preferred embodiments.

FIG. 1 is a comparison chart of wavelength band, frequency, and wavelength of radio (i.e. electromagnetic radiation);

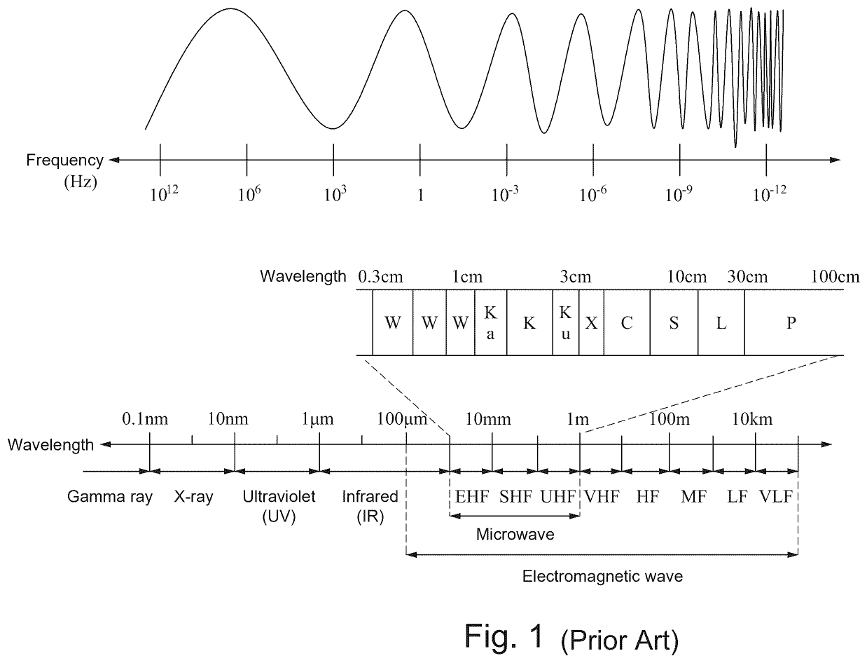

FIG. 2 is a schematic diagram demonstrating a partial area of a vehicle with an automotive LiDAR system in one embodiment of the present disclosure;

FIG. 3 is a schematic diagram demonstrating a partial area of an automotive LiDAR system described in FIG. 2;

FIG. 4 is a schematic diagram of various wavelength bands of an automotive LiDAR system;

FIG. 5 is a side view of a common recreational vehicle;

FIG. 6 is a side view of a truck;

FIG. 7 is a distribution diagram of the wavelength and reflectance of different windshields with different inclination angles;

FIG. 8 is a three-dimensional schematic diagram of a detection instrument;

FIG. 9 is the front view of an automotive LiDAR system in one embodiment of the present disclosure;

FIG. 10 is a cross-sectional schematic view of an automotive LiDAR system described in FIG. 9 along the 10-10 cutting plane line;

FIG. 11 is a cross-sectional schematic view of a partial area of the windshield of another embodiment of the present disclosure;

FIG. 12 is a three-dimensional schematic diagram demonstrating a partial area of a windshield described in FIG. 11.

### DETAILED DESCRIPTION OF THE PREFERRED EMBODIMENTS

A plurality of embodiments of the present disclosure are disclosed below with reference to drawings. For the purpose of clear illustration, many details in practice are provided together with the following descriptions. However, these detailed descriptions in practice are for illustration only and shall not be interpreted to limit the scope, applicability, or configuration of the present disclosure in any way. That is, in some embodiments of the present disclosure, these details in practice are not required. Furthermore, for the purpose of simplifying drawings, some structures and components of the prior art shown in the drawings are illustrated schematically.

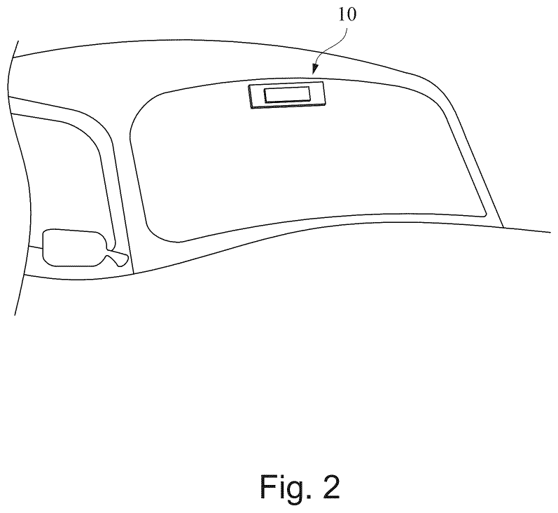

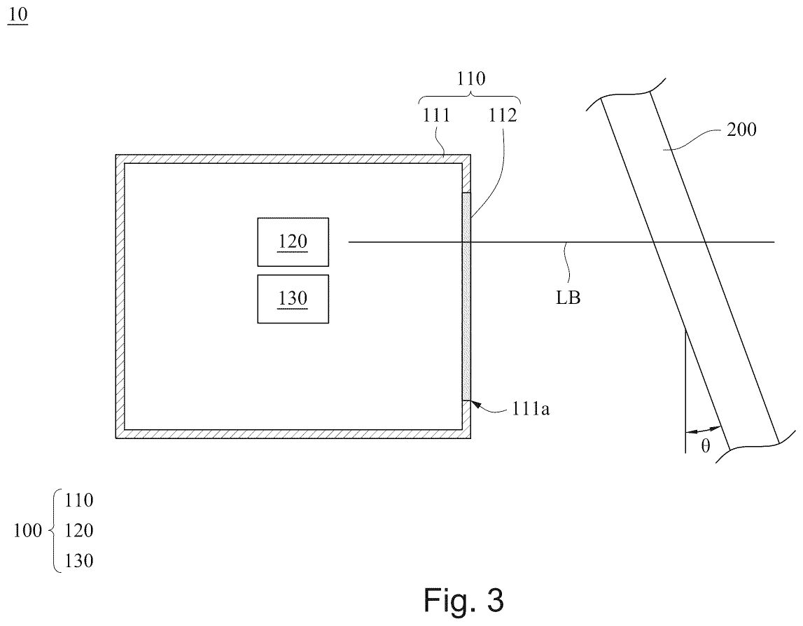

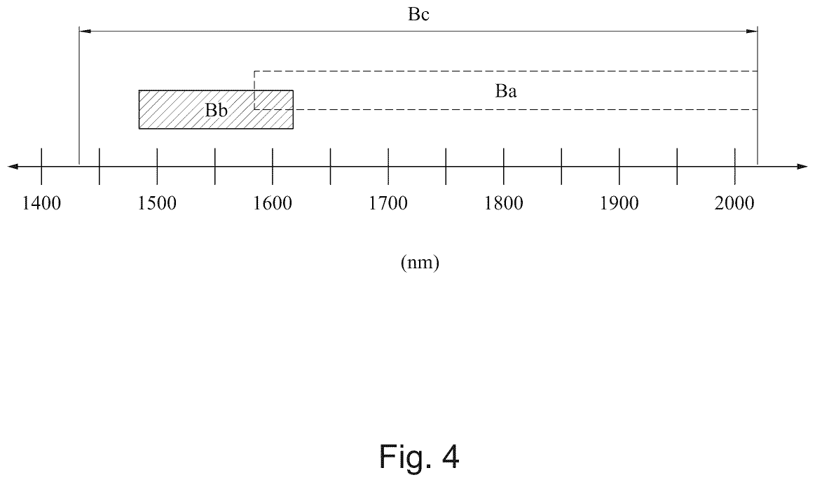

Please refer to FIG. 2, FIG. 3, and FIG. 4. FIG. 2 is a schematic diagram demonstrating a partial area of a vehicle with an automotive LiDAR system 10 in one embodiment of the present disclosure. FIG. 3 is a schematic diagram demonstrating a partial area of the automotive LiDAR system 10 described in FIG. 2. FIG. 4 is a schematic diagram of various wavelength bands of the automotive LiDAR system 10. In the embodiment, as shown in FIG. 2 to FIG. 4, the automotive LiDAR system 10 comprises a laser device 100 and a windshield 200. The laser device 100 comprises an enclosure 110, a light source 120, and a receiver 130. The enclosure 110 comprises housing 111 with an opening 111a and a light-transmitting window 112 disposed in the opening 111a. The light-transmitting window 112 comprises a magnetically conductive material configured to absorb electromagnetic waves in a wavelength band Ba of about 1600 nm to about 2000 nm. Actually, the reason that the light-transmitting window 112 is designed to absorb electromagnetic waves in the wavelength band Ba of about 1600 nm to about 2000 nm is because the light source 120 currently used is a near-infrared laser has a wavelength band of 1550 nm. Suppose electromagnetic waves in a wavelength band of about 1600 nm to about 2000 nm are not processed and absorbed. In that case, interference would definitely occur while detecting light with a wavelength band of 1550 nm emitted from the light source 120 during the reception process along the direction of a light beam LB described in FIG. 3. As a result, the receiver 130 would misjudge the real targeted signals. Please note that when the light source 120 is a laser having a wavelength band of 1550 nm, the receiver 130 generally would have a specific range of receiving bandwidths, instead of just accepting a bandwidth of 1550 nm. Therefore, it is necessary to manage the signal-to-noise ratio, which comes with the bandwidth, since microwave interference from the surrounding environment would lead to a poor signal-to-noise ratio. The light source 120 is disposed within the enclosure 110 and configured to emit the light beam LB having a wavelength band Bb of about 1500 nm to about 1600 nm. More specifically, the light source 120 can be a laser light source with a wavelength band of 1550 nm that has good directivity, for example, a distributed-feedback laser (DFB) laser diode emission source. However, the present invention is not limited thereto. In other words, when light from the light source 120 hits an external object and returns, theoretically, the preferable choice is that the receiver 130 only collects reflected waves of 1550 nm and is sufficient for LiDAR to scan a contour of the targeted object (i.e., the external object). The receiver 130 is disposed within the enclosure 110 and configured to detect optical signals in a wavelength band Bc of about 1450 nm to about 2000 nm. As described previously, the receiver 130 is generally designed to have a detecting bandwidth larger than the receiving bandwidth of a specific laser light source (for example, 1550 nm), in order to prevent incomplete signal reception. However, at the same time, the design would accept more wavelength bands from the surrounding environment, in addition to the targeted receiving bandwidth, that interfere with the bands and signal-to-noise ratio. Therefore, the present disclosure can solve the engineering and technical issues faced in practice. Environmental interfering light sources are mixed with light emitted from the light source 120 along the direction of the light beam LB described in FIG. 3 and return along the direction of the light beam LB during the reception process. The windshield 200 faces the light-transmitting window 112 and is configured to have a reflectance of about 8% to about 10% for environmental electromagnetic waves in the wavelength band Ba of about 1600 nm to about 2000 nm at certain angles. More specifically, by having a certain degree of reflection of environmental light of non-targeted wavelength bands, along with the absorption of environmental light of non-targeted wavelength bands, the design can help the receiver 130 to collect more targeted light with less non-targeted light and achieve the goal of improving the signal-to-noise ratio.

According to the aforementioned structural configuration, for the wavelength band Bc detected by the receiver 130 of the laser device 100, the automotive LiDAR system 10 of the embodiment uses the light-transmitting window 112 of the laser device 100 to absorb electromagnetic waves in the wavelength band Ba (about 1600 nm to about 2000 nm), together with the comprehensive effect by the windshield 200 to reflect electromagnetic waves of the wavelength band Ba to a certain degree (that is a reflectance of about 8% to about 10%), in order to effectively increase the signal-to-noise ratio of the receiver 130 for detecting the optical signals (that is about 1500 nm to about 1600 nm) of the wavelength band Bb (i.e., the desired wavelength band Bb). Please note that, in the present disclosure, FIG. 3 is used to explain the reflectance definition and measurement methods designed for experiments. In FIG. 3, the reflectance is defined as the light returning along the direction of the light beam LB from the right outside the windshield 200 toward the left. In other words, the reflectance addressed in the present disclosure refers to light from the environmental directions versus that returning from outside the windshield 200 specifically; namely, reflectance of the light source 120 or an environmental light source along the direction of the light beam LB entering the windshield 200, taking into account an inclination angle θ. Please also refer to Table 1 and Table 2.

In some embodiments, the magnetically conductive materials of the light-transmitting window 112 comprise p-type dopants or n-type dopants. Using such materials, the light-transmitting window 112 can achieve the aforementioned effect of absorbing electromagnetic waves in the wavelength band Ba of about 1600 nm to about 2000 nm. In some embodiments, the aforementioned magnetically conductive materials are electromagnetic interference (EMI) resistant materials.

In the embodiment shown in FIG. 3, after the light beam LB emitted by the light source 120 passes through the light-transmitting window 112, the light beam LB passes through a part of the windshield 200. This part of the windshield 200 is inclined with respect to the light-transmitting window 112 with the inclination angle θ. In some embodiments, the inclination angle θ of the aforementioned part of the windshield 200 with respect to the light-transmitting window 112 is smaller than about 50 degrees. For example, the inclination angle θ can be, but is not limited to, 20 degrees, 30 degrees, or 40 degrees.

In some embodiments, the windshield 200 is made of bare glass. Bare glass means a surface of the windshield 200 has no coating (for example, an anti-reflection (AR) coating formed by alternately stacking a plurality of layers of high and low reflectance together). In other words, the windshield 200 is made of bulk material glasses with a uniform texture.

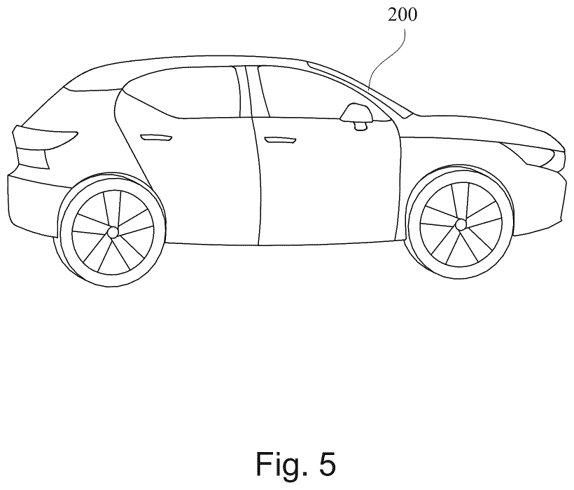

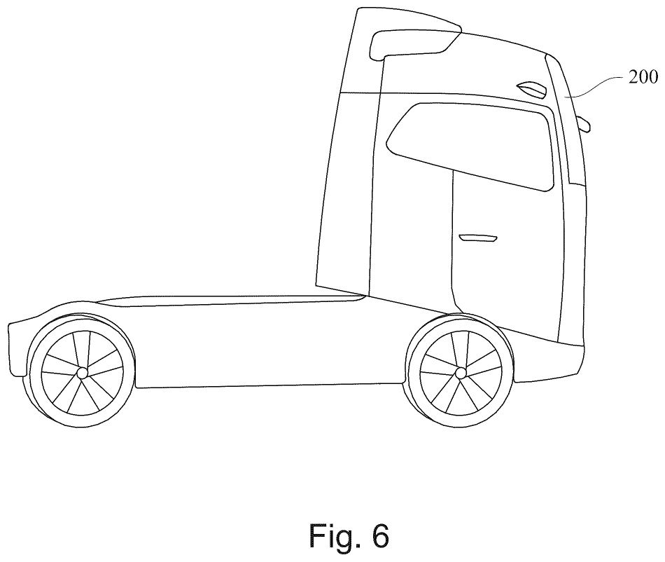

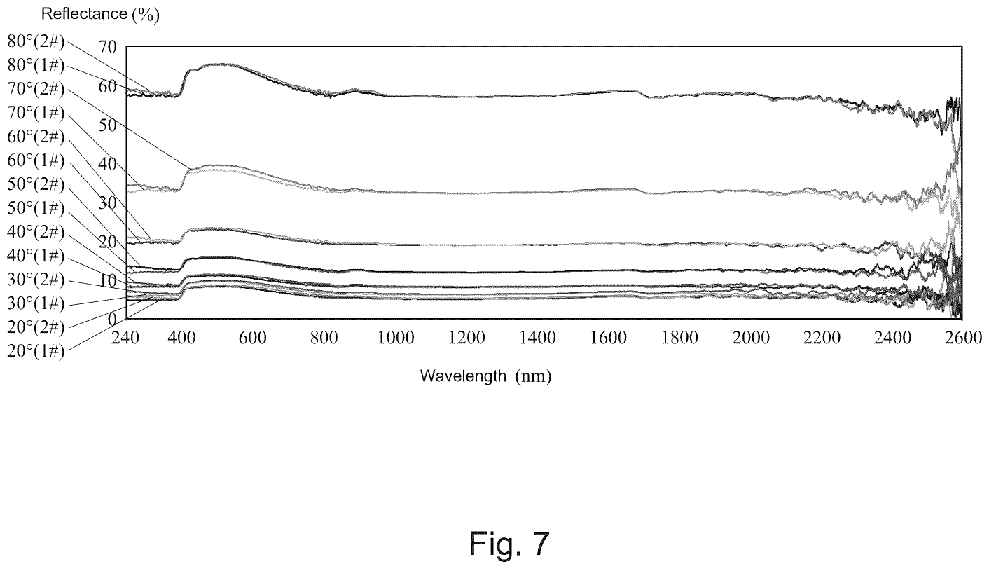

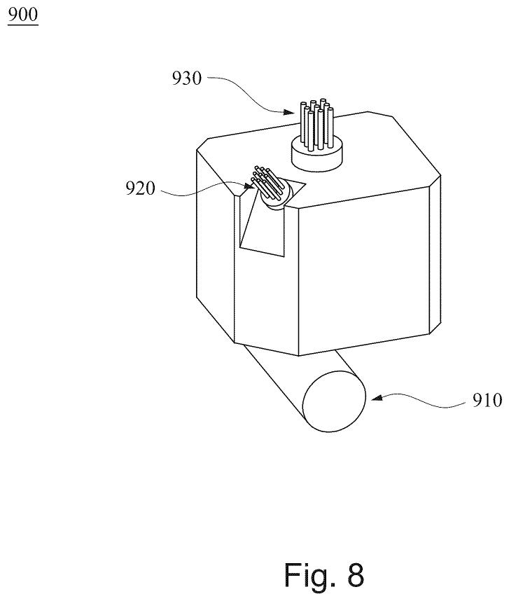

Please refer to FIG. 7. FIG. 7 is a distribution diagram of wavelength and reflectance of different windshields 200 with different inclination angles θ. More specifically, FIG. 7 is a distribution diagram of wavelength and reflectance of two types of windshields 200 at different inclination angles θ of 20 degrees, 30 degrees, 40 degrees, 50 degrees, 60 degrees, 70 degrees, and 80 degrees. For example, the inclination angle θ of the windshield 200 of a common recreational vehicle shown in FIG. 5 is about 45 degrees to 60 degrees; the inclination angle θ of the windshield 200 of a truck shown in FIG. 6 is about 5 degrees. Please note that the two types of bare glass made for the windshield 200 are manufactured by different commercial manufacturers (for example, BYD Company, Volkswagen, etc.) respectively, represented by codes 1# and 2# respectively. Please refer to FIG. 8. FIG. 8 is a three-dimensional schematic diagram of a detection instrument. The detection instrument is a spectrometer 900 of model SolidSpec-3700 manufactured by SHIMADZU Corporation. The spectrometer 900 is an all-band wave composite detector and comprises a photomultiplier tube (PMT) detector 910, an InGaAs detector 920, and a PbS detector 930. The spectrometer 900 can switch among a range of 700 nm to 1000 nm (preset switching wavelength is 870 nm) using the photomultiplier tube detector 910 and the InGaAs detector 920. The InGaAs detector 920 and the PbS detector 930 provide a range of switching among a range of 1600 nm to 1800 nm (preset switching wavelength is 1650 nm). The spectrometer 900 can detect direct light transmission, variable angle light transmission, and variable angle absolute reflectance of samples. Table 1 and Table 2 only list reflectance data of the two types of windshield 200 corresponding to specific wavelengths.

TABLE 1

| | Angle | | | | | | | |
|---|---|---|---|---|---|---|---|---|
| | 20° | | 30° | | 40° | | 50° | |
| Wavelength | 1# | 2# | 1# | 2# | 1# | 2# | 1# | 2# |
| (nm) | (%) | (%) | (%) | (%) | (%) | (%) | (%) | (%) |
| 1500 | 5.72 | 5.94 | 6.79 | 6.94 | 8.60 | 8.75 | 12.49 | 12.41 |
| 1550 | 5.86 | 6.09 | 7.00 | 7.09 | 8.72 | 8.86 | 12.59 | 12.53 |
| 1600 | 6.00 | 6.23 | 7.10 | 7.26 | 8.82 | 8.94 | 12.73 | 12.62 |
| 1650 | 6.06 | 6.28 | 7.16 | 7.29 | 8.84 | 8.92 | 12.78 | 12.68 |
| 1700 | 5.72 | 5.76 | 6.77 | 6.93 | 8.60 | 8.69 | 12.45 | 12.36 |
| 1750 | 5.69 | 5.63 | 6.58 | 6.91 | 8.46 | 8.63 | 12.27 | 12.52 |
| 1800 | 6.06 | 5.99 | 7.03 | 7.25 | 8.55 | 8.95 | 12.45 | 12.60 |
| 1850 | 5.80 | 6.03 | 6.91 | 7.25 | 8.42 | 8.91 | 12.66 | 12.82 |
| 1900 | 6.20 | 5.95 | 6.80 | 7.47 | 8.48 | 9.11 | 12.58 | 12.86 |
| 1950 | 6.19 | 6.12 | 6.64 | 7.68 | 8.25 | 9.00 | 12.67 | 12.74 |
| 2000 | 5.83 | 5.97 | 6.53 | 7.46 | 8.48 | 9.00 | 12.81 | 12.68 |

TABLE 2

| | Angle | | | | | |
|---|---|---|---|---|---|---|
| | 60° | | 70° | | 80° | |
| Wavelength | 1# | 2# | 1# | 2# | 1# | 2# |
| (nm) | (%) | (%) | (%) | (%) | (%) | (%) |
| 1500 | 19.36 | 19.35 | 32.79 | 32.98 | 57.64 | 57.83 |
| 1550 | 19.51 | 19.49 | 33.00 | 33.31 | 57.95 | 58.20 |
| 1600 | 19.59 | 19.63 | 33.12 | 33.50 | 58.52 | 58.46 |
| 1650 | 19.62 | 19.72 | 33.28 | 33.56 | 58.44 | 58.59 |
| 1700 | 19.34 | 19.16 | 32.68 | 32.63 | 57.52 | 57.45 |
| 1750 | 19.32 | 18.97 | 32.42 | 32.30 | 57.00 | 56.86 |
| 1800 | 19.48 | 19.32 | 32.75 | 32.79 | 57.43 | 57.45 |
| 1850 | 19.64 | 19.45 | 32.76 | 32.95 | 57.38 | 57.78 |
| 1900 | 19.49 | 19.52 | 33.05 | 33.13 | 57.91 | 57.89 |
| 1950 | 19.43 | 19.42 | 32.99 | 33.08 | 57.55 | 57.80 |
| 2000 | 19.09 | 19.27 | 33.11 | 32.91 | 57.84 | 58.08 |

According to FIG. 7, Table 1, and Table 2, it is apparent that when the inclination angle θ of the windshield 200 with respect to the light-transmitting window 112 of the laser device 100 is smaller than about 50 degrees (please note that if the inclination angle θ is larger than 60 degrees, the reflectance would be too large and would simultaneously reflect too much-returned light of a targeted wavelength band of 1550 nm during the returning course resulting in a negative effect. Therefore, an inclination angle smaller than about 50 degrees is preferable), The windshield 200 has a reflectance of less than 12% for environmental electromagnetic waves in a wavelength band of about 1600 nm to about 2000 nm. More specifically, when the windshield 200 has an inclination angle θ of about 40 degrees with respect to the light-transmitting window 112 of the laser device 100, the windshield 200 has a reflectance of about 8% for environmental electromagnetic waves in a wavelength band of about 1600 nm to about 2000 nm. When the windshield 200 has an inclination angle θ of about 30 degrees with respect to the light-transmitting window 112 of the laser device 100, the windshield 200 has a reflectance of about 7% for environmental electromagnetic waves in a wavelength band of about 1600 nm to about 2000 nm. When the windshield 200 has an inclination angle θ of about 20 degrees with respect to the light-transmitting window 112 of the laser device 100, the windshield 200 has a reflectance of about 6% for environmental electromagnetic waves in a wavelength band of about 1600 nm to about 2000 nm. By the same token, when the windshield 200 has an inclination angle θ of about 40 degrees to about 45 degrees with respect to the light-transmitting window 112 of the laser device 100, the windshield 200 has a reflectance of about 8% to about 10% for environmental electromagnetic waves in a wavelength band of about 1600 nm to about 2000 nm.

Please note that, according to FIG. 7, with any inclination angle θ, the reflectance of a wavelength band of about 1500 nm to about 1600 nm is not significantly different from the reflectance of a wavelength band of about 1600 nm to about 2000 nm. Therefore, when the reflectance of a wavelength band of about 1600 nm to about 2000 nm is too small (for example, the inclination angle smaller than 20 degrees), even though the receiver 130 can better capture optical signals having a wavelength band of about 1500 nm to about 1600 nm, the reflectance effect on electromagnetic waves in a wavelength band of about 1600 nm to about 2000 nm is poor. Therefore, the receiver 130 cannot increase the comprehensive effect of the signal-to-noise ratio by having magnetically conductive materials in the light-transmitting window 112. On the other hand, if the reflectance of a wavelength band of about 1600 nm to about 2000 nm is too large (for example, the inclination angle larger than 50 degrees), the reflectance of waves in a wavelength band of about 1500 nm to about 1600 nm would be large, resulting in the signal-to-noise ratio of the receiver 130 in detecting a wavelength band of about 1500 nm to about 1600 nm being poor. Therefore, as explained previously, by configuring the inclination angle θ of the windshield 200 to be about 40 degrees to about 45 degrees with respect to the light-transmitting window 112 of the laser device 100, the signal-to-noise ratio of the receiver 130 can be increased effectively for detecting the optical signals of about 1500 nm to about 1600 nm.

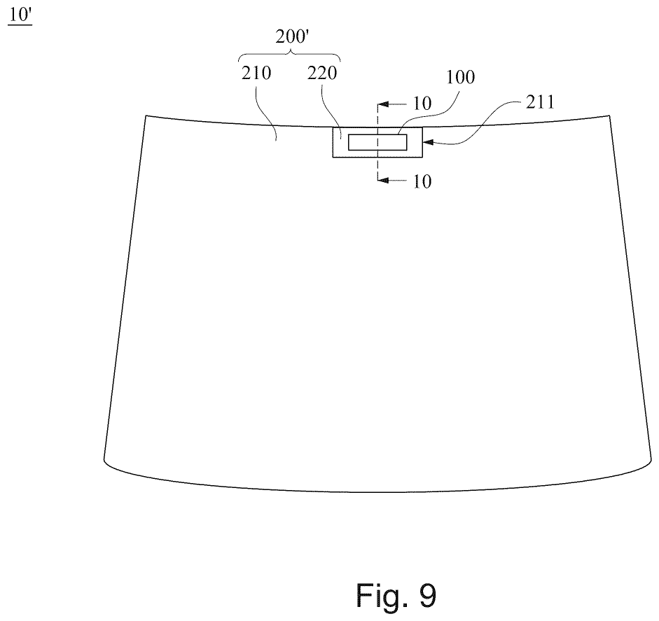

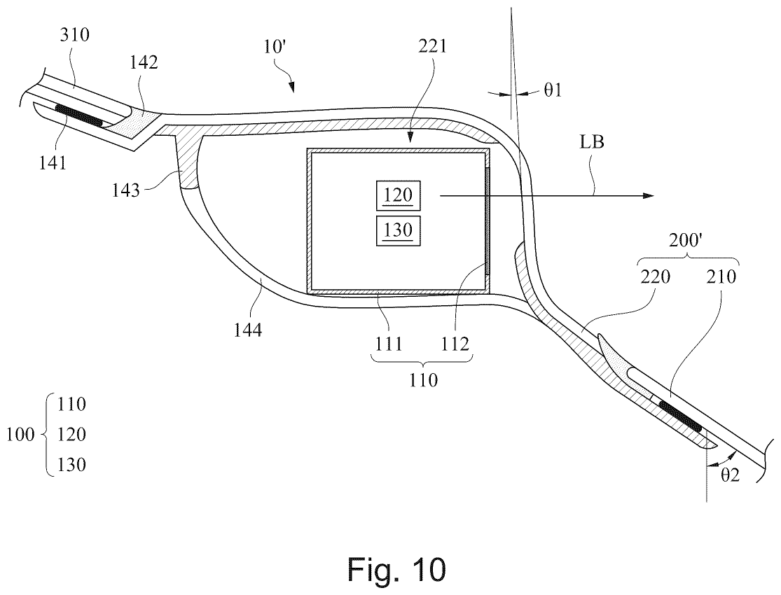

Please refer to FIG. 9 and FIG. 10. FIG. 9 is the front view of an automotive LiDAR system 10′ in one embodiment of the present disclosure. FIG. 10 is a cross-sectional schematic view of an automotive LiDAR system 10′ described in FIG. 9 along the 10-10 cutting plane line. In the embodiment shown in FIG. 9 and FIG. 10, the LiDAR system comprises a laser device 100 and a windshield 200′, wherein the laser device 100 is the same as that in the embodiment described in FIG. 3. Relevant explanations can be referenced in the aforementioned descriptions and will not be repeated again. In comparison with the embodiment shown in FIG. 3, the windshield 200′ of the embodiment comprises a substrate component 210 and a splicing component 220. The substrate component 210 has a gap 211. The splicing component 220 is spliced in the gap 211 and has a concave part 221. The laser device 100 is disposed at least partially within the concave part 221. The light beam LB passes through a part of the splicing component 220. The inclination angle θ1 of this aforementioned part with respect to the light-transmitting window 112 is smaller than the inclination angle θ2 of the substrate component 210 with respect to the light-transmitting window 112. Therefore, the substrate component 210 is inclined steeper than the aforementioned part of the splicing component 220.

In some embodiments, the inclination angle θ1 of the aforementioned part of the splicing component 220 with respect to the light-transmitting window 112 is smaller than 50 degrees. For example, the inclination angle θ1 can be, but is not limited to, 20 degrees, 30 degrees, or 40 degrees.

In some embodiments, the splicing component 220 of the windshield 200′ is made of bare glass. Bare glass means a surface of the splicing component 220 has no coating (for example, an anti-reflection (AR) coating formed by alternately stacking a plurality of layers of high and low reflectance together). In other words, the splicing component 220 of the windshield 200′ is made of bulk material glasses with a uniform texture.

In some embodiments, the splicing component 220 of the windshield 200′ is made of bare glass, and the inclination angle θ1 of the aforementioned part of the splicing component 220 is configured to be about 40 degrees to about 45 degrees with respect to the light-transmitting window 112. Through such configuration, the aforementioned part of the splicing component 220 has a reflectance of about 8% to about 10% for environmental electromagnetic waves in a wavelength band of about 1600 nm to about 2000 nm.

In the embodiment shown in FIG. 10, the LiDAR system further comprises an adhesive strip 141, a sealing component 142, an internal component 143, and a cap 144. The internal component 143 is disposed on an internal side surface (extending to the concave part 221) of the splicing component 220 of the windshield 200′. The internal component 143 extends downward toward the substrate component 210 of the windshield 200′ and faces the internal side surface of the substrate component 210. Furthermore, the splicing component 220 extends upward toward a roof panel 310 and is opposite to an internal side surface of the roof panel 310. The adhesive strip 141 is disposed on and surrounds the splicing component 220 to fasten between an internal side surfaces of the internal component 143 and the substrate component 210, as well as between the internal side surfaces of the splicing component 220 and the roof panel 310. The sealing component 142 further fills in gaps between the internal side surfaces of the internal component 143 and the substrate component 210, as well as between the internal side surfaces of the splicing component 220 and the roof panel 310, in order to create fairly good sealing relative to the outside environment and seamless joints to prevent noise while the vehicle is moving. The cap 144 is configured to be removable and assembled to the internal component 143 so that the laser device 100 can be disposed within a holding space surrounded and formed by the splicing component 220, the internal component 143, and the cap 144. The cap 144 can be used as a base that supports the laser device 100. In some embodiments, one side of the cap 144 away from the laser device 100 can further be installed with a rear-view mirror.

In some embodiments, the internal component 143 is composed of polycarbonate (PC), polyethylene (PE), polymethyl methacrylate (PMMA), polypropylene (PP), polystyrene, polybutadiene, polynitrile, polyester, polyurethane, polyacrylate, polyamide, polyethylene terephthalate (PET), polybutylene terephthalate (PBT), preferably acrylonitrile-butadiene-styrene (ABS), acrylate-styrene-acrylonitrile (ASA), acrylonitrile-butadiene-styrene polycarbonate (ABS+PC), PET+PC, PBT+PC, PBT+PC and/or copolymers, block copolymers or their mixtures. Furthermore, the internal component 143 can comprise inorganic or organic fillers, preferably SiO₂, Al₂O₃, TiO₂, clay minerals, silicates, zeolites, glass fibers, carbon fibers, glass balls, organic fibers, and/or mixtures thereof.

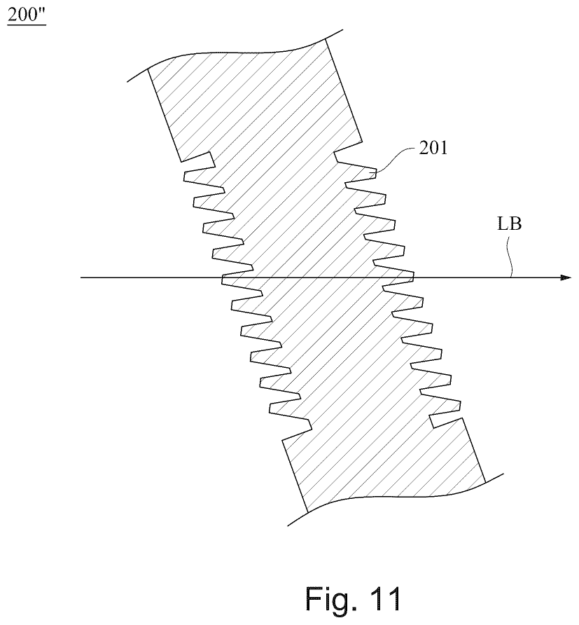

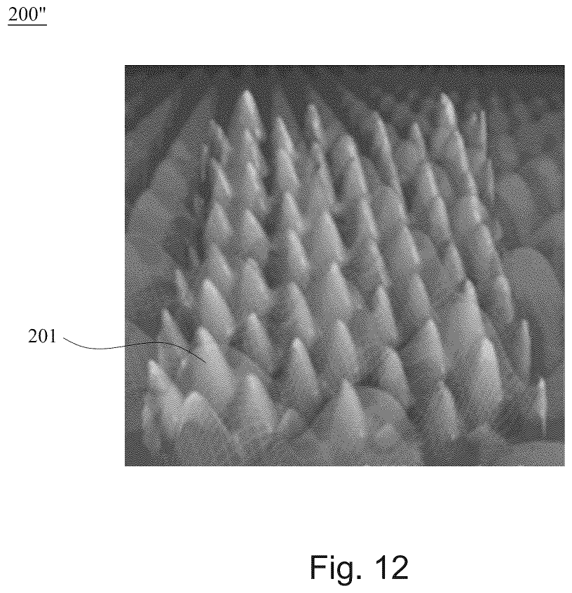

Please refer to FIG. 11 and FIG. 12. FIG. 11 is a cross-sectional schematic view of a partial area of the windshield 200″ of another embodiment of the present disclosure. FIG. 12 is a three-dimensional schematic diagram demonstrating a partial area of a windshield 200″ described in FIG. 11. In the embodiment shown in FIG. 11 and FIG. 12, the windshield 200″ has a plurality of microstructures 201 in the location where the light beam LB emitted from the light source 120 passes through. The microstructures 201 are distributed on two opposite sides of the aforementioned part of the windshield 200″. More specifically, every microstructure 201 has the shape of a cone. For example, through the etching process implemented on the windshield 200″, microstructures 201 are formed on two opposite sides of the windshield 200″. By disposing microstructures 201 in the area of the windshield 200″ where the light beam LB passes through, the light transmittance of the windshield 200″ for the light beam LB is increased, while the transmittance deterioration at all incident angles is reduced. Based on the actual experiments, in comparison with bare glass without the aforementioned microstructures 201, the windshield 200″ having the aforementioned microstructures 201 can increase the light beam LB transmittance by about 6% to about 8% and reduce the transmittance deterioration from every incident angle (for example, 0 degrees to 80 degrees) by about 15%. By increasing the quantity of light of the light beam LB passing through the windshield 200″, the quantity of reflected light of the light beam LB through the windshield 200″ detected by the receiver 130 would increase accordingly, and the signal-to-noise ratio can be increased.

In some embodiments, the windshield 200″ is included with respect to the light beam LB, whereas the direction to which the microstructures 201 extend is in parallel with the light beam LB. In other words, the direction to which the microstructures 201 extend is not perpendicular to the surface of the windshield 200″.

According to the embodiments of the present disclosure described above, it is apparent that for the wavelength bands detectable by the receiver of the laser device in the LiDAR system of the present disclosure, through the light-transmitting window of the laser device absorbing environmental electromagnetic waves of specific wavelength bands, together with the windshield reflecting environmental electromagnetic waves of specific wavelength bands to a certain level, the signal-to-noise ratio of the optical signals (corresponding to the wavelength bands of the light beam emitted from the light source of the laser device) of desired wavelength bands detected by the receiver can be increased effectively. Furthermore, by limiting the inclination angle of the windshield with respect to the light-transmitting window of the laser device to be smaller than 50 degrees, the windshield can meet the aforementioned effect of reflecting electromagnetic interference. By adding p-type dopants or n-type dopants in the magnetically conductive materials of the light-transmitting window, the light-transmitting window can meet the aforementioned comprehensive effect of absorbing electromagnetic waves. By disposing microstructures in the part of the windshield where the light beams pass through, the transmittance of the light beam in the windshield is increased, and the transmittance deterioration of every inclination angle is reduced. By having a certain degree of reflection of environmental light of non-targeted wavelength bands, along with the absorption of environmental light of non-targeted wavelength bands, the design can help the receiver to collect more targeted light with less non-targeted light and achieve the goal of improving the signal-to-noise ratio. The spirit of the present disclosure is to simultaneously use the light-transmitting window of the laser device to introduce the concept of absorbing material. Furthermore, it combines the complex, comprehensive effect of utilizing the windshield to reflect the wavelength bands that do not belong to the desired wavelength bands specified by the receiver in order to eliminate environmental light and improve the signal-to-noise ratio effectively.

The above-preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure and shall be included in the appended claims.

### COMPONENT SYMBOL

10, 10′: automotive LiDAR system
100: Laser device
110: Enclosure
111: Housing
111a: Opening
112: Light-transmitting window
120: Light source
130: Receiver
141: Adhesive strip
142: Sealing component
143: Internal component
144: Cap
200, 200′, 200″: Windshield
201: Microstructure
210: Substrate component
211: Gap
220: Splicing component
221: Concave part
310: Roof panel
900: Spectrometer
910: Photomultiplier tube detector
920: InGaAs detector
930: PbS detector
LB: Light beam
Ba, Bb, Bc: Wavelength band
θ, θ1, θ2: Inclination angle

What is claimed is:

1. An automotive light detection and ranging (LiDAR) system comprising:
a laser device comprising:
an enclosure comprising a housing with an opening and a light-transmitting window disposed in the opening, wherein the light-transmitting window comprises a magnetically conductive material configured to absorb electromagnetic waves in a wavelength band of about 1600 nm to about 2000 nm;
a light source, disposed within the enclosure and configured to emit a light beam having a wavelength band of about 1500 nm to about 1600 nm; and
a receiver, disposed within the enclosure and configured to detect optical signals in a wavelength band of about 1450 nm to about 2000 nm; and
a windshield facing the light-transmitting window and configured to have a reflectance of about 8% to about 10% for environmental electromagnetic waves in a wavelength band of about 1600 nm to about 2000 nm.

2. The automotive LiDAR system of claim 1, wherein the light beam passes through a part of the windshield, and the part is tilted with respect to the light-transmitting window.

3. The automotive LiDAR system of claim 2, wherein the part of the windshield has an inclination angle smaller than about 50 degrees with respect to the light-transmitting window.

4. The automotive LiDAR system of claim 3, wherein the inclination angle is larger than about 20 degrees.

5. The automotive LiDAR system of claim 4, wherein the inclination angle ranges from about 40 degrees to about 45 degrees.

6. The automotive LiDAR system of claim 1, wherein the windshield is made of bare glass.

7. The automotive LiDAR system of claim 1, wherein the windshield comprises:
a substrate component having a gap; and
a splicing component, spliced in the gap and having a concave part, wherein the laser device is disposed at least partially within the concave part.

8. The automotive LiDAR system of claim 7, wherein the light beam passes through a part of the splicing component, an inclination angle of the part with respect to the light-transmitting window is smaller than an inclination angle of the substrate component with respect to the light-transmitting window.

9. The automotive LiDAR system of claim 1, wherein the magnetically conductive material comprises p-type dopants or n-type dopants.

10. The automotive LiDAR system of claim 1, wherein the light beam passes through a part of the windshield, and the part comprises a plurality of microstructures.
